(19) United States
(12) Patent Application Publication
(10) Pub. No.: US 2014/0089738 A1
(43) Pub. Date: Mar. 27, 2014

(54) SYSTEM AND METHOD FOR IDENTIFYING SOURCE OF RUN-TIME EXECUTION FAILURE

(71) Applicant: Tata Consultancy Services Limited, Mumbai (IN)

(72) Inventors: Ravi Mahamuni, Pune (IN); Shivani Sharma, Pune (IN); Kejul Pravin Kalyani, Pune (IN)

(73) Assignee: Tata Consultancy Services Limited, Mumbai (IN)

(21) Appl. No.: 14/037,758

(22) Filed: Sep. 26, 2013

(30) Foreign Application Priority Data
Sep. 27, 2012 (IN) 2850/MUM/2012

(51) Int. Cl. G06F 11/36

(52) U.S. Cl. CPC G06F 11/3688
USPC 714/38.1

(57) ABSTRACT

The present disclosure relates to identifying the source of run-time execution failure and performing static analysis on the computer program without changing actual computer program code. In one embodiment, a method for performing static analysis on run-time execution failure is disclosed, comprising: identifying a point of interest in a computer program by statically analyzing the computer program, wherein the point of interest comprises one of: a variable or an expression; identifying previous assignments of the variable or the expression by performing static analysis depending on a value associated with the variable or the expression; modifying the value to a new value or modifying the expression to a new expression; modifying the computer program based upon the new value or the new expression to generate a modified computer program; and performing incremental static analysis on the modified computer program in order to identify a change in the computer program.

### PRIORITY CLAIM

This U.S. patent application claims priority under 35 U.S.C. §119 to: India Application No. 2850/MUM/2012, filed Sep. 27, 2012. The aforementioned application is incorporated herein by reference in its entirety.

### TECHNICAL FIELD

The present disclosure in general relates to a field of computer program analysis. More particularly, the disclosure relates to identifying the source of run-time execution failure and performing static analysis on the computer program without changing actual computer program code.

### BACKGROUND

Obtaining software right has proven to be a challenging task, despite decades of research and practice. Most of the available software contains defects. Finding the defects or errors or run-time execution failure in computer programs is easy in cases whereas, some may never be found. The reason for not finding all defects may be likelihood of defects appearing or not appearing during testing. In several instances, the defects may appear relatively often go unnoticed. The reason such defects remain unnoticed is that, either they may are not apparent as defects or error or they may not be severe. Computer program defects may be of several types which include logical errors, functional errors, runtime errors, etc. Fixing defects at a later stage of software deployment phase is usually not economic and employs higher financial aid.

Software defects of different types may be detected by using currently available compilers for statically typed languages. The defects may be detected during different phases of SDLC. The defects may be found at early stage in code review process or may be found at production phase. Further, defects may be found by static analysis tools or may be found at the time of manual code reviews. The most popular approach for finding defects is software testing. Although software testing identifies most of the defects, testing is not feasible for finding all the defects. Testing requires unwanted effort and is also time intensive since it is applied only to executable code towards the end of the development process.

The alternative approach for detecting defects in software is, using static analysis tools. Static analysis tools are used to find runtime errors, resource leaks and security vulnerabilities, statically, without executing the code. Static program analysis is analysis of computer software performed without actually executing programs. Current static analytics tools report the defects and review points in the code. Considerable time needs to be spent in reviewing the defects and the review points reported by such tools.

Once the defect is reported by any of the approaches at any time, analyzing the root cause of the existing defect and how the defect may be removed, consumes substantial amount of time since it is done manually. In order to fix the defect and verify its impact, the user may be required to make necessary changes in actual source code and follow the same process of testing or static analysis again on the whole source code. Further, the user may have to find the defect existence and otherwise analyze whether the changes in actual code has introduced another defect. There are limited solutions available for checking the effects of the changes made in source code quickly.

### SUMMARY

This summary is provided to introduce concepts related to systems and methods for performing static analysis on run-time execution failure in a computer program and the concepts are further described below in the detailed description. This summary is not intended to identify essential features of the claimed subject matter nor is it intended for use in determining or limiting the scope of the claimed subject matter.

In one implementation, a method for performing static analysis on run-time execution failure in a computer program is disclosed. The method comprises identifying a point of interest in the computer program by statically analyzing the computer program. The point of interest comprises a variable or an expression causing the run-time execution failure. The method further comprises identifying previous assignments of the variable or the expression by performing static analysis depending on a value associated with the variable. The method further comprises allowing modification of the value of the variable to a new value or modification of the expression to a new expression. The method further comprises modifying the computer program based upon the new value or the new expression to generate a modified computer program. The method further comprises performing incremental static analysis on the modified computer program in order to identify a change in the computer program. The method steps of the identifying, the finding, the allowing, the modifying the computer program, and the performing incremental static analysis is performed by a processor using programming instructions stored in a memory.

In one implementation, a system for performing static analysis on run-time execution failure in a computer program is disclosed. The system comprises a processor and a memory coupled to the processor. The processor is capable of executing a plurality of modules stored in the memory. The plurality of modules comprises an identification module configured to identify a point of interest in the computer program. The point of interest comprises a variable or an expression causing the run-time execution failure. The plurality of modules comprises an analysis module configured to perform static analysis to identify previous assignments of the variable or the expression depending on a value associated with the variable. The plurality of modules further comprises a modifying module configured to allow to modify the value of the variable to a new value or to allow to modify the expression to a new expression, thereby modifying the computer program based upon the new value or the new expression to generate a modified computer program. The plurality of modules further comprises a static analysis module configured to perform incremental static analysis on the modified computer program in order to identify change in the computer program.

In one implementation, a computer program product for performing static analysis on run-time execution failure in a computer program is disclosed. The computer program product comprises a program code for identifying a point of interest in the computer program by statically analyzing the computer program. The point of interest comprises a variable or an expression causing the run-time execution failure. The computer program product further comprises a program code for identifying previous assignments of the variable or the expression by performing static analysis depending on a value associated with the variable. The computer program product further comprises a program code for allowing to modify the value of the variable to a new value or allowing to modify the expression to a new expression. The computer program product further comprises a program code for modifying the computer program based upon the new value or the new expression to generate a modified computer program. The computer program product further a program code comprises for performing incremental static analysis on the modified computer program in order to identify a change in the computer program.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer to like features and components.

FIG. 1 illustrates a network implementation of a system for performing static analysis on run-time execution failure in a computer program, in accordance with an embodiment of the present subject matter.

FIG. 2 illustrates various modules of system, in accordance with an embodiment of the present subject matter.

FIG. 3 illustrates a method for performing static analysis on run-time execution failure in a computer program, in accordance with an embodiment of the present subject matter.

FIG. 4 illustrates a method for performing static analysis on run-time execution failure, in accordance with an exemplary embodiment of the present subject matter.

FIGS. 5A, 5B and 5C illustrate a method for performing static analysis on run-time execution failure, in accordance with another exemplary embodiment of the present subject matter.

### DETAILED DESCRIPTION

System(s) and method(s) for performing static analysis on run-time execution failure in a computer program are described. A point of interest in the computer program is identified by statically analyzing the computer program. The point of interest may comprise a variable or an expression or a combination causing the run-time execution failure in the computer program. The source of run-time execution failure is identified by performing a backward pass i.e. tracing the previous assignments and other participating expression(s)

The value of the variable or the expression may be modified at a variable definition or at any program point thereby modifying the computer program. Incremental static analysis is performed on the modified computer program to identify effect of the change in the computer program execution. The change made to the computer program with a new value or the new expression may be accepted or rejected depending on an impact of change in execution of the computer program.

While aspects of described system and method for performing static analysis on run-time execution failure in a computer program may be implemented in any number of different computing systems, environments, and/or configurations, the embodiments are described in the context of the following exemplary system.

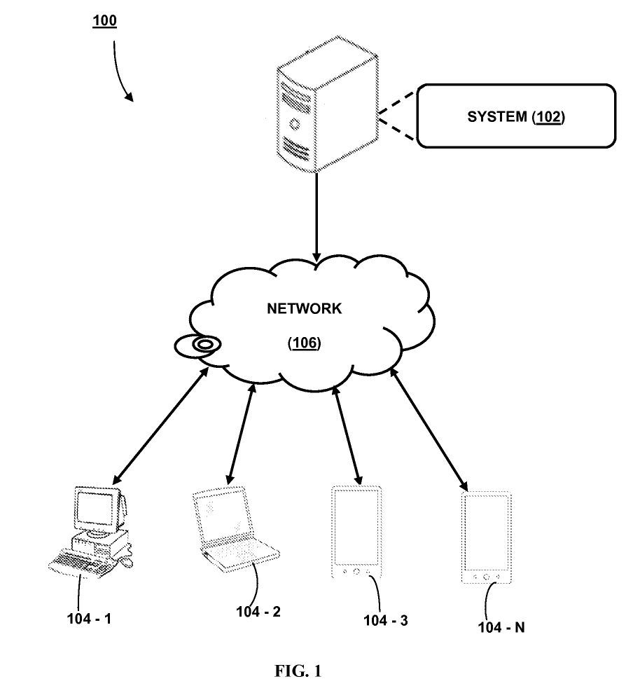

Referring now to FIG. 1, a network implementation 100 of a system 102 for performing static analysis on run-time execution failure is illustrated, in accordance with an embodiment of the present subject matter. In one embodiment, the system 102 provides performing static analysis on a computer program. The point of interest is identified which may be causing run-time failure. Backward pass assignment (Backward pass) may be performed to identify previous value or participating expression(s) for the variables in the point of interest. The value of the variable or the expression may be changed to a new value or to a new expression. Incremental static analysis is performed on the computer program with new value or the new expression to identify a change in execution of the computer program.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

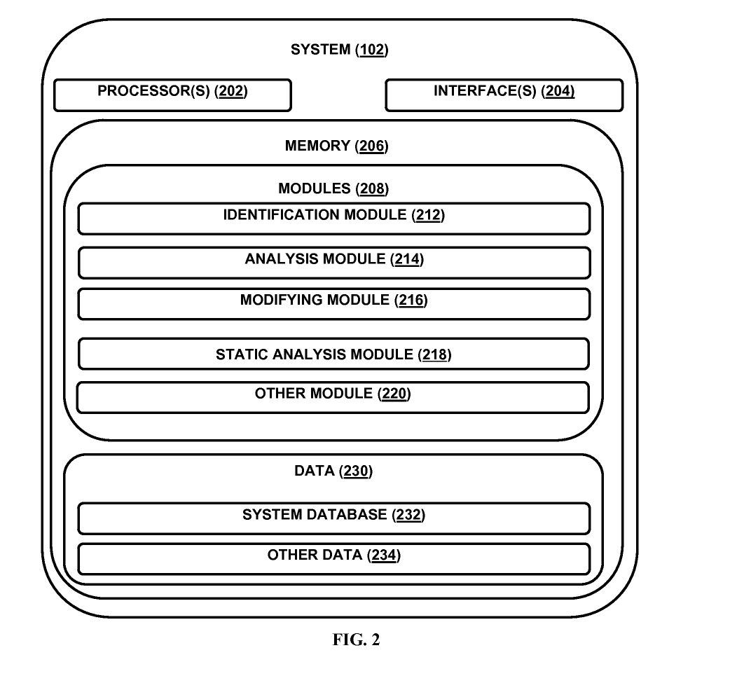

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an identification module 212, an analysis module 214, a modifying module 216, a static analysis module 218 and other modules 220. The other modules 220 may include programs or coded instructions that supplement applications and functions of the system 102.

The data 230, amongst other things, serves as a repository for storing data processed, received, and generated by one or more of the modules 208. The data 230 may also include a system database 232, and other data 234. The other data 234 may include data generated as a result of the execution of one or more modules in the other module 220.

In one implementation, static analysis is performed on a computer program without executing an actual computer program code. The computer program may comprise one or more variables or expression causing run-time execution failure in the computer program. In order to find source of the run-time execution failure, the identification module 212 may be configured to identify a point of interest in the computer program. The point of interest may be identified by static analysis tools or at the time of manual code reviews or at testing phase or at production phase. Identifying the point of interest in the computer program by other techniques other than mentioned above is obvious to persons skilled in the art. The point of interest may comprise a variable or an expression causing the run-time execution failure. In one embodiment, the run-time execution failure may be similar to defect(s) in the computer program. Further, the point of interest may comprise one or more expression that may comprise at least two variables to form an expression.

In one implementation, the analysis module 214 may be configured to perform static analysis to identify previous assignments of the variable or the expression depending on a value associated with the variable. The static analysis may be performed based on run-time execution failure type, run-time execution failure classification that may identify a source of each of the run-time execution failure or class of run-time execution failure in the computer program. In one embodiment, the run-time execution failure may be caused due to the value of the variable divided by zero or array index out of bounds or overflow or underflow in the value of the variable or may be caused by other parameters. The run-time execution failure may be caused by other parameters that may be known and is obvious to those persons skilled in the art.

The previous assignment of the variable may be identified by performing backward pass. The backward pass facilitates the user to reach to one or more declarations or definitions in which the value of the variable may be defined till the point of interest in the computer program. By performing backward pass, the source of the run-time failure may be identified at previous definitions of the variable or other participating expression(s). The run-time failure may be caused due to the value which may be defined by any assignment to the variable that is unequal to an intended value. In one embodiment, the intended value may be the value required to execute the computer program. The variable or the expression may comprise the value or the expression respectively, which may be unequal to the intended value or the intended expression. The unequal value or unequal expression that is not intended may be the source of the run-time failure. In one embodiment, the backward pass may facilitate in showing the multiple paths from entry point function of the program till the point of interest and in selecting a path for traversing.

In one implementation, upon identifying the previous assignment of the variables or the expression causing the run-time failure, the value of the variable may be modified. The modifying module 216 may be configured to allow the user to modify the value of the variable to a new value or to allow to modify the expression to a new expression, thereby modifying the computer program based upon the new value or the new expression to generate a modified computer program. The system 102 may facilitate the user to change the value or the expression causing the run-time execution failure at the definitions of the variable or the expression to the new value or to the new expression.

In one implementation, the static analysis module 218 may be configured to perform incremental static analysis on the modified computer program in order to identify change in the computer program. In one embodiment, the system 102 may allow user to perform forward pass assignment (forward pass) to analyze the effect of the change in the computer program. The forward pass facilitates the user to reach to one or more next usages or assignments of the variable in the computer program. In one embodiment, the user may be provided with one or more possible solutions which may be a result of change in the value of the variable or the expression to the new value or the new expression respectively in the computer program.

In one embodiment, the forward pass may be performed for the next usage of the variable from the point of interest. Further, performing forward pass facilitates the user to reach to next assignment of the variable from the variable definition may be for changing the value of the variable in the computer program. The next assignment of the variable from the variable definition may comprise the value causing run-time failure, such that the user may also change the value of the variable to the new value in the computer program.

In one embodiment, the system 102 may allow the user to verify the effect of the change made with the new value or the new expression in the computer program. The static analysis may be performed on the computer program using one or more data flow analysis techniques that are obvious to persons those skilled in the art.

The static analysis performed on the computer program by the system 102 is different from the debugging of the computer program. In the process of debugging the computer program, a certain portion of the computer program and exact inputs for the computer program may be required. Further, the computer program and exact inputs to the computer program code may be executed in order to find the effect of the change in the computer program. The system 102 performs static analysis to analyze run-time execution failure by identifying the source of the run-time execution failure. The system 102 allows the user to modify the value or the expression causing the run-time execution failure and analyzes the effect of the change in the computer program. In one embodiment, the user may accept or reject the effect of the change in the computer program depending on run-time execution of the computer program.

In one implementation, the system 102 may facilitate in providing collapsed view of the computer program with respect to the point of interest. The collapsed view with respect to the point of interest may be portion of the computer program that may be impacting the point of interest. The collapsed view facilitates the user in reaching to the source of the run-time execution failure in the computer program. In one embodiment, in the case of variable having multiple values from multiple paths in the actual computer program code, the system 102 may visualize the exact previous assignment of the variable of which the variable is generated.

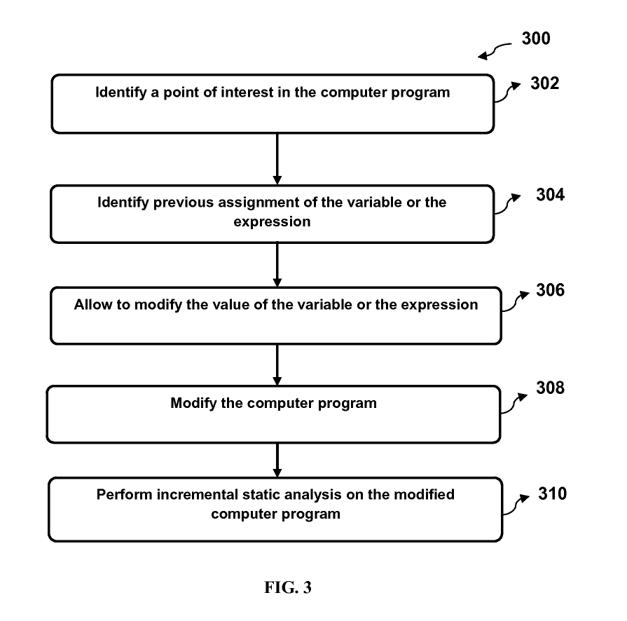

Referring now to FIG. 3, a method 300 for performing static analysis on run-time execution failure in a computer program is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, a point of interest in the computer program may be identified by statically analyzing the computer program. The point of interest may comprise a variable or an expression causing the run-time execution failure. In one implementation, the point of interest may be identified by the identification module 212.

At block 304, previous assignments of the variable or other participating expression(s) may be identified by performing static analysis depending on a value associated with the variable. In one implementation, the analysis may be performed by the analysis module 214.

At block 306, the value of the variable or the expression may be modified to a new value or to a new expression in the computer program. Further, at block 308, the computer program may be modified based upon the new value or the new expression to generate a modified computer program. In one implementation, the computer program may be modified by the modifying module 216.

At block 310, incremental static analysis may be performed on the modified computer program in order to identify a change in the computer program. The static analysis may be performed by the static analysis module 218.

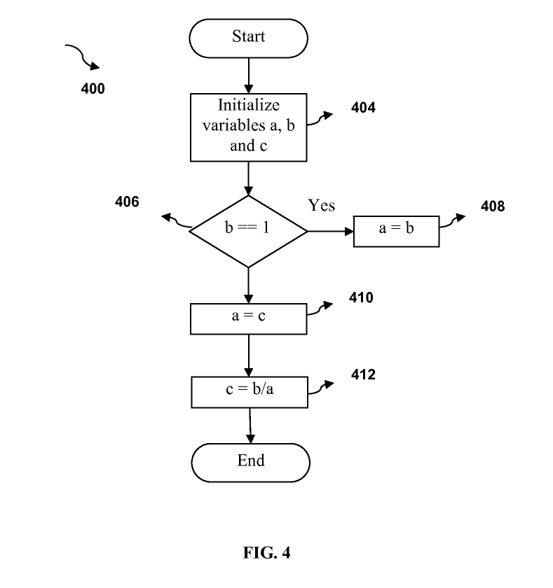

Referring now to FIG. 4, a non-limiting exemplary method 400 for performing static analysis on run-time execution failure in a computer program is shown, in accordance with an exemplary embodiment of the present subject matter. At step 404, variables ‘a’, ‘b’ and ‘c’ are initialized. The variable ‘b’ may be assigned value 2 and ‘c’ with 0 respectively. At step 406, it may be checked for if the value of variable ‘b’ is equal to 1. If the value of the variable ‘b’ is equal to 1, at step 408, the value of the variable ‘b’ is assigned to variable ‘a’. If the value of the variable ‘b’ is not equal to 1, at step 410, the value of the variable ‘c’ may be assigned to the variable ‘a’. At step 412, the variable ‘c’ is assigned with the value obtained by dividing the value of the variable ‘b’ with the value of the variable ‘a’.

The point of interest may be identified by the identification module 212. Considering that point of interest in the computer program is ‘a’ at step 412 where the value of ‘a’ at step 412 is ‘0’ causing the run-time execution failure. Static analysis is performed on the computer program to check the source of the variable getting value ‘0’ at the point of interest using backward pass. Previous assignments of the variable or other participating expression(s) may be identified by performing static analysis by the analysis module 214. The variable ‘a’ is highlighted in previous definition going backward from the point of interest i.e., step 412. The value of ‘a’ is defined at step 410, therefore, step 410 may be highlighted. Further, the expression ‘a=c’ is defined at step 410 may be next point of interest. The previous definition of ‘c’ is highlighted i.e., at step 404. From the analysis, the source of the run-time execution failure may be identified as ‘c=0’ at step 404. The user may change the value of ‘c’ at step 404 and check the effect of change in the computer program execution. In one embodiment, the system 102 may facilitate the user that the run-time execution failure is caused by value division by zero.

The system 102 may provide collapsed view of the computer program at step 412 with respect to the variable ‘a’. Further, the user may identify the source of the run-time execution failure by performing backward pass in the computer program with or without opting for collapsed view.

Further, the computer program may be modified based upon the new value or the new expression to generate a modified computer program by the modifying module 216. For the above example, considering that the user modifies the value of the variable of ‘c’ to 1 at step 404. Incremental static analysis may be performed on the modified computer program in order to identify a change in the computer program by the static analysis module 218. By performing forward pass, the next usage of the variable ‘c’ may be highlighted at step 410. The value of variable ‘a’ may be changed to ‘1’. Further, performing forward pass, the next usage of the variable ‘a’ i.e., step 412 may be highlighted. The value of ‘a’ changed to 1 at step 412, thereby having modified value at point of interest. The user may accept or reject the change in the computer program depending on the effect of change in the modified computer program. The system 102 may provide collapsed view of the computer program at step 412 with respect to the variable ‘a’.

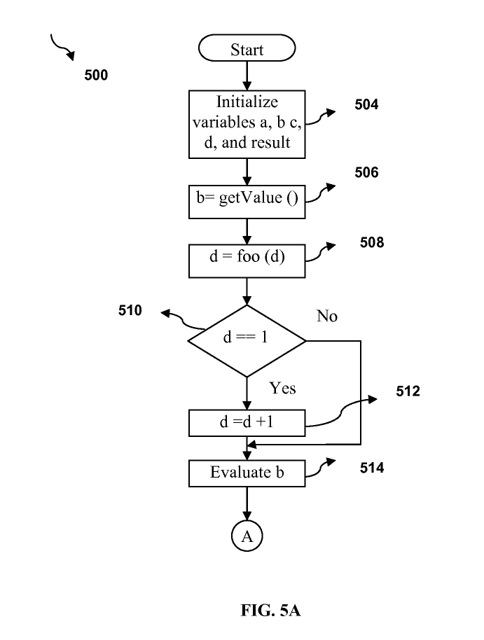

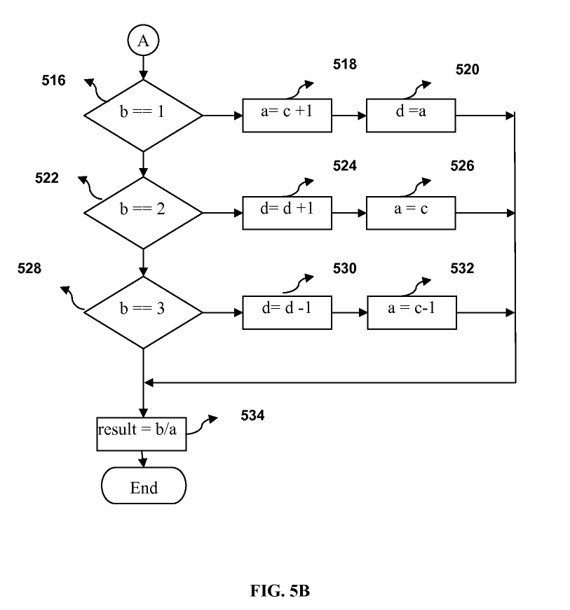

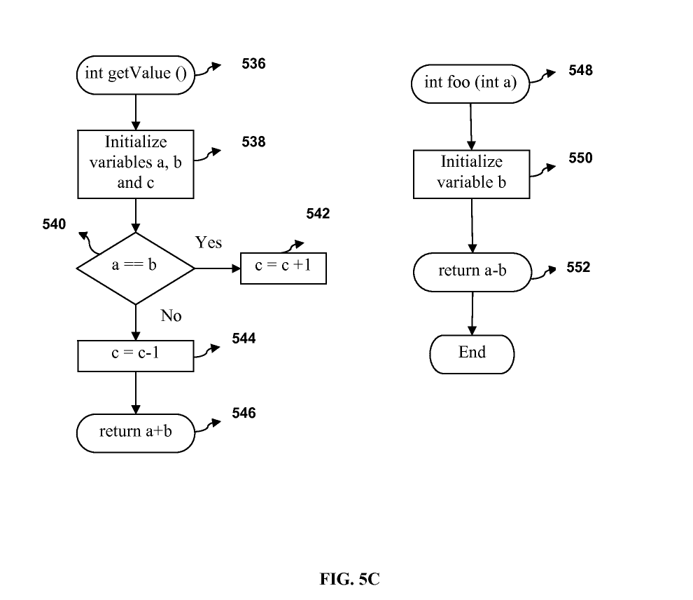

Referring now to FIGS. 5A, 5B and 5C, a non limiting exemplary method 500 for performing static analysis on run-time execution failure in a computer program is shown, in accordance with another exemplary embodiment of the present subject matter. At step 504, the variables ‘a’, ‘b’, ‘c’, ‘d’ and result may be initialized. Further, at step 506, the variable ‘b’ may be assigned the value returned by the function getValue( ). At step 508, the variable ‘d’ may be assigned the value returned by the function foo(d). Further, at step 510, it may be checked if the value of the variable ‘d’ is equal to 1. If the value of the variable ‘d’ is equal to 1, at step 512, the variable ‘d’ may be assigned the value by incrementing the value of the variable ‘d’ with 1. At step 514, the switch statement is initiated by evaluating the value of the variable ‘b’. At step 516, it may be checked if the value of the variable ‘b’ is equal to 1. If the value of the variable ‘b’ is equal to 1, steps 518 and 520 are performed. At step 518, the variable ‘a’ may be assigned with the value of the variable ‘c’ incremented by 1. Further at step 520, the variable ‘d’ may be assigned with the value of the variable ‘a’.

Further, at step 522 it may be checked if the value of the variable ‘b’ is equal to 2. If the value of the variable ‘b’ is equal to 2, then steps 524 and 526 are performed. At step 524, the variable ‘d’ may be assigned the value by incrementing the value of the variable ‘d’ with 1. At step 526, the variable ‘a’ may be assigned with the value of the variable ‘a’.

At step 528, it may be checked if the value of the variable ‘b’ is equal to 3. If the value of the variable ‘b’ is equal to 3, steps 530 and 532 are performed. At step 530, the variable ‘d’ may be assigned with the value of ‘d’ decreased by 1. At step 532, the variable ‘a’ is assigned the value of the variable ‘c’ decreased by 1. At step 534, the variable result is assigned the value obtained by dividing the value of the variable ‘b’ with the value of the variable ‘a’.

Further, referring to FIG. 5C, the execution of the functions int getValue( ) and int foo (int a) is disclosed. At step 538, the variables ‘a’, ‘b’ and ‘c’ are initialized. At step 540, it may be checked for if the value of the variable ‘a’ is equal to the value of the variable ‘b’. If the value of the variable ‘a’ is equal to the value of the variable ‘b’, at step 542, the value of the variable ‘c’ is assigned the value of the variable ‘c’ incremented by 1. If the value of the variable ‘a’ is not equal to the value of the variable ‘b’, at step 544, the value of the variable ‘c’ may be assigned the value of the variable ‘c’ decreased by 1. At step 546, the value obtained by adding the value of the variable ‘a’ and the value of the variable ‘b’ may be returned.

Further, the execution of the function int foo (int a) is described. At step 550, the variable ‘b’ may be initialized. At step 552, the value obtained by subtracting the value of the variable ‘b’ from the value of the variable ‘a’ is returned.

The following values may be considered for the purpose of explaining the example, short a=5, b, result=0, short c=1, int d=1. The point of interest may be identified by the identification module 212. By performing static analysis the point of interest may be identified at the step 534. The system 102 may present that the run-time execution failure at step 534 for division by zero where value of variable ‘a’ may be zero when control is defined at step 528 using switch statement. In one embodiment, the user may visualize the computer program in collapsed view with respect to the step 534.

In order to identify source of run-time failure, backward pass may be performed. Previous assignments of the variable other participating expression(s) may be identified by performing static analysis by the analysis module 214. The system 102 may provide information on possible solution to the user by highlighting previous definition of variable such as at step 518, variable is ‘a’ comprises value 2, at step 526 variable comprise expression ‘a=c’ comprises value 1, at step 532 variable comprise expression ‘a=c−1’ comprises value 0 and at step 534 variable ‘a’ comprises values 5, 2, 1, 0. The value assigned at step 532 is ‘0’, the source of run-time execution failure may be identified as at step 532.

The system 102 may present information on possible solution to the user as shown at step 552. For example, the system 102 may present information to the user to change the value of the variable ‘c’ to 2. Further, forward pass may be performed to verify the effect of change in the modified computer program and incremental static analysis is performed on the modified computer program. The change may result in, at step 504 value of the variable ‘a’ is 5, at step 518 value of variable ‘a’ is 3, at step 524 value of the variable ‘a’ is 2, at step 532 value of the variable ‘a’ is 1 and at step 534 value of the variable ‘a’ is 5, 3, 2, 1. The system 102 presents that at step 532, the value of variable is modified. The computer program may be modified based upon the new value or the new expression to generate a modified computer program by the modifying module 216. The user may accept or reject the change in the computer program at step 532.

In addition, the system 102 may present information to user to change the value of the variable as an alternate solution. The original computer program may be presented to the user if the user rejects the effect of the modified computer program i.e., the value of the variable ‘c’ being 2. The system 102 may present information to user to change the expression at step 532 to ‘a=c+1’. Incremental static analysis may be performed on the modified computer program in order to identify a change in the computer program by the static analysis module 218. The effect of the modified expression at step 532 may be verified by the system 102. The change may result in, at step 504 value of the variable ‘a’ is 5, at step 518 value of the variable ‘a’ is 2, at step 526 value of the variable ‘a’ is 1, at step 532 value of the variable ‘a’ is 2 and at step 534 value of the variable is 5, 2, 1. The system 102 may present that the run-time execution failure is fixed. The user may accept or reject the change in the computer program at step 532.

Although implementations for methods and systems for performing static analysis on run-time execution failure in a computer program have been described in language specific to structural features and/or methods, it is to be understood that the appended claims are not necessarily limited to the specific features or methods described. Rather, the specific features and methods are disclosed as examples of implementations for performing static analysis on run-time execution failure in a computer program.

We claim:

1. A method for performing static analysis on run-time execution failure in a computer program, the method comprising:
identifying a point of interest in a computer program by statically analyzing the computer program, wherein the point of interest comprises one of: a variable or an expression;
identifying previous assignments of the variable or the expression by performing static analysis depending on a value associated with the variable or the expression;
modifying the value to a new value or modifying the expression to a new expression;
modifying, via a processor, the computer program based upon the new value or the new expression to generate a modified computer program; and
performing incremental static analysis on the modified computer program in order to identify a change in the computer program.

2. The method of claim 1, wherein the value is unequal to a value required to execute the computer program.

3. The method of claim 1, wherein the static analysis is performed using one or more data flow analysis techniques.

4. A system for performing static analysis to analyze run-time execution failure in a computer program, the system comprising:
a processor; and
a memory coupled to the processor, wherein the processor is capable of executing a plurality of modules stored in the memory, the plurality of modules comprising:
an identification module configured to identify a point of interest in a computer program, wherein the point of interest comprises one of: a variable or an expression;
an analysis module configured to perform static analysis to identify previous assignments of the variable or the expression depending on a value associated with the variable or the expression;
a modifying module configured to allow modification of the value of the variable to a new value or modification of the expression to a new expression to generate a modified computer program; and
a static analysis module configured to perform incremental static analysis on the modified computer program in order to identify a change in the computer program.

5. The system of claim 4, wherein the value is unequal to a value required to execute the computer program.

6. The system of claim 4, wherein the static analysis is performed using one or more data flow analysis techniques.

7. A computer program product for performing static analysis to analyze run-time execution failure in a computer program, the computer program product comprising program instructions for:
identifying a point of interest in a computer program by statically analyzing the computer program, wherein the point of interest comprises one of: a variable or an expression;
identifying previous assignments of the variable or the expression depending on a value associated with the variable or the expression;
allowing modification of the value of the variable to a new value or modification of the expression to a new expression;
modifying the computer program based upon the new value or the new expression to generate a modified computer program; and
performing incremental static analysis on the modified computer program in order to identify a change in the computer program.

8. The computer program product of claim 7, wherein the value is unequal to a value required to execute the computer program.

9. The computer program product of claim 7, wherein the static analysis is performed using one or more data flow analysis techniques.
